(19) United States
(12) Patent Application Publication
(10) Pub. No.: US 2010/0243154 A1
(43) Pub. Date: Sep. 30, 2010

(54) Cured In Place Pipe Liner With Styrene Barrier

(75) Inventors: Robert J. Wiessner, Bladel (NL); Joseph J. Vontorcik, JR., Broadview Heights, OH (US); Donald A. Meltzer, Akron, OH (US)

Correspondence Address: THE LUBRIZOL CORPORATION, 29400 LAKELAND BLVD, MAIL DROP 022B, WICKLIFFE, OH, 44092-2298, US

(73) Assignee: LUBRIZOL ADVANCED MATERIALS, INC., Cleveland, OH (US)

(21) Appl. No.: 12/719,902

(22) Filed: Mar. 9, 2010

Related U.S. Application Data
(60) Provisional application No. 61/162,725, filed on Mar. 24, 2009.

(51) Int. Cl. B32B 37/00; D04H 13/00; B32B 27/30; B32B 27/40; B32B 27/34; B32B 27/36; B32B 27/32; B32B 5/00

(52) U.S. Cl. 156/293; 442/394; 442/396; 428/423.1; 428/474.4; 428/480; 428/523; 428/500; 428/335; 428/336; 428/339

(57) ABSTRACT

A liner for repairing damaged pipes, such as underground sewer or gas pipes is disclosed. The liner comprises a TPU coating on fibrous mat of non-woven fabric. The TPU coating contains a barrier layer to retard the migration of styrene from the liner to the media used to force the liner against the damaged pipe and to activate the thermoset resin. The thermoset resin converts the liner from a flexible state to a rigid state as the liner is cured in place inside the pipe.

### CROSS REFERENCE TO RELATED APPLICATION

This application claims priority from Provisional Application Ser. No. 61/162,725 filed on Mar. 24, 2009.

### FIELD OF THE INVENTION

The present invention relates to liners for pipes or various other passageways. More specifically, this invention relates to liners for underground sewers which are used to repair broken, pitted, or leaking main sewer pipes, lateral sewer pipes and gas pipes. The invention is directed to cured in place liners which have a barrier layer which is resistant to migration of styrene. That is, the liners are cured inside the pipe to be repaired. The invention is also directed to cured in place liners which use a styrene based polyester thermoset resin saturated fabric where the thermoset resin is cured (hardened) by the use of heat.

### BACKGROUND OF THE INVENTION

The cured in place method of lining damaged or broken pipes, such as sewers and gas pipes, has become a very successful method of repairing underground pipes. The method avoids the need, to excavate the underground pipe and the resulting damage to surface infrastructure, such as paved streets and buildings. The cured in place method involves first positioning the liner inside the pipe while the liner is in a flexible state, then curing the liner to a hard state within the pipe while forcing the liner against the inside of the damaged pipe. Conventional methods use air, steam or water to pressurize the liner to have the flexible liner conform to the inside of the pipe and cure the liner to a hard state while it is held by the pressure to the inside of the pipe.

The prior art liners have been made by using a fabric on one side of the liner and a single layer polymer sheet on the other side. The fabric is saturated with an uncured thermoset material, such as a styrene based polyester resin or epoxy resin. The curing, that is the process of converting the thermoset material to a rigid state, is performed after the liner has been placed inside the pipe. The liner can be placed in the pipe to be repaired by either the dragged-in method as described in U.S. Pat. No. 4,009,063 or the inversion method as described in U.S. Pat. No. 4,064,211, both of these patents are herein incorporated by reference. The polymer sheet placed on the fabric must be resistant to the thermosetting material used and also able to withstand the heat used to cure the thermoset material. Various thermoplastics and elastomers have been used to coat the fabrics, with polyurethane being frequently used. Thermoplastic polyurethane is particularly desirable because of its abrasion resistance, tear resistance and elastic properties.

One problem that occurs when using a styrene based polyester as the thermosetting resin is the migration of styrene from the resin and through the thermoplastic polymer layer coated on the resin absorbent material layer. The styrene enters the cavity of the cured in place pipe and contaminates the media, such as water or steam, used to pressurize the pipe liner. When the media is evacuated from the pipe, it must be specially processed because it is contaminated with styrene, rather than simply being diverted to the local city sewer system. Also, the styrene odor which must also be dealt with can be a problem.

It would be desirable to have a thermoplastic layer which would greatly reduce the styrene migration into the media used to pressurize the pipe liner and allow the media to be processed through normal sewer treatment facilities. Installation costs could be reduced and the environment could be improved by such a development.

### SUMMARY OF THE INVENTION

A cured in place liner for a passageway or pipe comprising a barrier layer to greatly reduce the migration of styrene through the liner. The liner has at least one layer of resin absorbent material, preferably a non-woven resin absorbent material. The liner also has a thermoset resin, preferably a styrene polyester resin, impregnated into the resin absorbent material layer. The liner has a thermoplastic coating attached to the resin absorbent material layer. The coating comprises a thermoplastic barrier layer, which is preferably either a high hardness thermoplastic polyurethane polymer or an ethylene vinyl alcohol polymer. The coating is preferably a three layer coating comprising (a) a first thermoplastic layer in contact with the resin absorbent material layer; (b) a second thermoplastic barrier layer in contact with the first thermoplastic layer and third thermoplastic layer; and (c) a third thermoplastic layer in contact with the barrier layer. The first and third layers of the coating can be made from a thermoplastic polymer selected from the group consisting of thermoplastic polyurethane (TPU), co-polyamide (COPA) and co-polyester (COPE).

In the most preferred embodiment, the resin absorbent material layer is a non woven polyester fabric, the thermoset resin is a styrene polyester resin, and the coating is a three layer coating having polyester thermoplastic polyurethane polymer (TPU) as the first and third layer and a barrier layer (second layer) of either high hardness TPU or ethylene vinyl alcohol (EVOH) polymer between the first and third layers.

### DETAILED DESCRIPTION OF THE INVENTION

The cured in place liner for a passageway or pipe is comprised of: (a) at least one resin absorbent material layer; (b) a thermosettable resin absorbed into the resin absorbent material layer; and (c) a thermoplastic coating or film comprising a barrier material. Preferably, the thermoplastic coating is a three layer film having a first thermoplastic layer in contact with the resin absorbent material layer, a second thermoplastic barrier layer, and a third thermoplastic layer in contact with the barrier layer. The second thermoplastic barrier layer can be either a high hardness TPU or EVOH polymer. The first and third layers of the coating can be the same or different, and can be TPU, COPA or COPE polymers. An example of a co-polyamide (COPA) polymer is one commercially available as Pebax® from Arkema. An example of a co-polyester (COPE) polymer is one commercially available as Hytrel® from DuPont. The most preferred embodiment is to use TPU polymers for all three layers of the coating, with the first and third layer being low hardness TPU (less than 98 Shore A) and the second barrier layer being a TPU having high hardness (60 Shore D or greater). The barrier layer of high hardness TPU is disposed between the first and third layers of low hardness TPU. The invention will be described in terms of the most preferred embodiment of using TPU for all three layers of the coating. The coating in this specification means a film.

### TPU for First and Third Layers of Coating

Thermoplastic polyurethane (TPU) polymers used for the first and third layers in this invention are made by reaction of three reactants. The first reactant is a hydroxyl terminated intermediate, such as a polyester, polyether, polycarbonate or mixtures thereof hydroxyl terminated intermediate. The second reactant is a glycol or amine chain extender with a glycol chain extender being preferred. The third reactant is an isocyanate, preferably a diisocyanate. Each of the preferred three reactants is discussed below.

The hydroxyl terminated polyester intermediate is generally a linear polyester having a number average molecular weight (Mn) of from about 1000 to about 10,000, desirably from about 2000 to about 5000, and preferably from about 2000 to about 3000. The molecular weight is determined by assay of the terminal functional groups and is related to the number average molecular weight. The hydroxyl terminated polyester intermediate preferably has a low acid number, such as less than 1.5, preferably less than 1.0 and more, preferably less than 0.8. A low acid number for the hydroxyl terminated polyester intermediate is preferred for liners which come in contact with moisture, because low acid numbers improve the hydrolytic stability of the TPU polymer. Acid number is determined according to ASTM D-4662 and is defined as the quantity of base, expressed in milligrams of potassium hydroxide that is required to titrate acidic constituents in 1.0 gram of sample. Hydrolytic stability can also be improved by adding hydrolytic stabilizers to the TPU which are known to those skilled in the art of formulating TPU polymers. The hydroxyl terminated polyester intermediates are produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred, so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is the preferred acid. The glycols which are reacted to form a desirable polyester intermediate can be aliphatic, aromatic, or combinations thereof, and have a total of from 2 to 12carbon atoms, and include ethylene glycol, diethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and the like, 1,4-butanediol is the preferred glycol. A blend of two or more glycols may be used. For a liner to be used to line a pipe where microbial resistance is required, such as gas pipes, diethylene glycol is the preferred glycol.

Suitable glycol chain extenders used as the second reactant to make the TPU polymer used in the first and third layers can be aliphatic, aromatic or combinations thereof and have from 2 to about 12 carbon atoms. Preferably, the glycol chain extenders are lower aliphatic or short chain glycols having from about 2 to about 10 carbon atoms and include, for instance, ethylene glycol, diethylene glycol, propylene glycol, dipropylene glycol, 1,4-butanediol, 1,6-hexanediol 1,3-butanediol, 1,5-pentanediol, 1,4-cyclohexanedimethanol hydroquinone, di(hydroxyethyl) ether, neopentyglycol, and the like, with 1,4-butanediol being preferred, Aromatic glycols can be used as the chain extender to make the TPU including benzene glycol and xylene glycol. Xylene glycol is a mixture of 1,4-di(hydroxymethyl) benzene and 1,2-di(hydroxymethyl) benzene. Benzene glycol specifically includes hydroquinone, i.e., bis (beta-hydroxyethyl) ether also known as 1,4-di(2-hydroxyethoxy) benzene; resorcinol, i.e., bis(beta-hydroxyethyl) ether also known as 1,3-di(2-hydroxyethyl) benzene; catechol, i.e., bis(beta-hydroxyethyl) ether also known as 1,2-di(2-hydroxyethoxy) benzene; and combinations thereof. A mixture of two or more glycols may be used as the chain extender in the TPU of this invention. A mixture of 1,4-butanediol and 1,6-hexanediol is the preferred mixture.

The third reactant to make the TPU for the first and third layers of this invention is a diisocyanate. Suitable diisocyanates include aromatic diisocyanates such as: 4,4′-methylenebis-(phenyl isocyanate) (MDI); m-xylylene diisocyanate (XDI), phenylene-1,4-diispcyanate, 1,5-naphthalene diisocyanate, diphenylmethane-3,3′-dimethoxy-4,4′-diisocyanate (TODI) and toluene diisocyanate (TDI); as well as aliphatic diisocyanates such as isophorone diisocyanate (IPDI),; 1,4-cyclohexyl diisocyanate (CHDI), decane-1,10-diisdcyariate, hexamethylene diisocyanate (HDI), and dicyclohexylmethane-4,4′-diisocyanate. The most preferred diisocyanate is 4,4′-methylenebis (phenyl isocyanate), i.e., MDI. A mixture of two or more diisocyanates can be used. Also, small amounts of isocyanates having a functionality greater than 2, such as triisocyanates can be used together with the diisocyanates. Large amounts of isocyanates with a functionality of 3 or more should be avoided as they will cause the TPU polymer to be crosslinked and thus interfere with its ability to be melt processed.

The three preferred reactants (hydroxyl terminated polyester intermediate, glycol chain extender, and diisocyanate) are reacted together to form the high molecular weight TPU used in the first and third layers of the TPU coating of this invention. Any known processes to react the three reactants may be used to make the TPU. The preferred process as a so-called one-shot process where all three reactants are added to an extruder reactor and reacted. The equivalent weight amount of the diisocyanate to the total equivalent weight amount of the hydroxyl containing components, that is, the hydroxyl terminated polyester intermediate arid the chain extender glycol, is from about 0.95 to about 1.10, desirably from about 0.96 to about 1.02, and preferably from about 0.97 to about 1.005. Reaction temperatures utilizing urethane catalyst are generally from about 175° C. to about 245° C. and preferably from 180° C. to 220° C.

Generally, any conventional catalyst can be utilized to react the diisocyanate with the polyester intermediates or the chain extender and the same is well known to the art and to the literature. Examples of suitable catalysts include, the various alkyl ethers or alkyl thiol ethers of bismuth or tin wherein the alkyl portion has from 1 to about 20 carbon atoms with specific examples including bismuth octoate, bismuth laurate, and the like. Preferred, catalysts include the various tin catalysts such as stannous octoate, dibutyltin dioctoate, dibutyltin dilaurate, and the like. The amount of such catalyst is generally small such as from about 20 to about 200 parts per million based upon the total weight of the polyurethane forming reactants.

The thermoplastic polyurethane can also be prepared utilizing a pre-polymer process. In the pre-polymer route, the hydroxyl terminated polyester intermediates are reacted with generally an equivalent excess of one or more diisocyanates to form a pre-polymer solution having free or unreacted diisocyanate therein. Reaction is generally carried out at temperatures of from about 80° C. to about 220° C. and preferably from about 150° C. to about 200° C. in the presence of a suitable urethane catalyst. Subsequently, a selective type of chain extender as noted above is added in an equivalent amount generally equal to the isocyanate end groups as well as to any free or unreacted diisocyanate compounds. The overall equivalent ratio of the total diisocyanate to the total equivalent of the hydroxyl terminated polyesters and the chain extender is thus from about 0.95 to about 1.10, desirably from about 0.96 to about 1.02 and preferably from about 0.97 to about 1.005. The equivalent ratio of the hydroxyl terminated polyesters to the chain extender is adjusted to give the desired shore hardness. The chain extension reaction temperature is generally from about 180° C. to about 250° C. with from about 200° C. to about 240° C. being preferred. Typically, the pre-polymer route can be carried out in any conventional device with an extruder being preferred. Thus, the polyester intermediates are reacted with an equivalent excess of a diisocyanate in a first portion of the extruder to form a pre-polymer solution and subsequently the chain extender is added at a downstream portion and reacted with the pre-polymer solution. Any conventional extruder can be utilized, with extruders equipped with barrier screws having a length to diameter ratio of at least 20 and preferably at least 25 are preferred.

Useful additives can be utilized in suitable amounts and include opacifying pigments, plasticizers, colorants, mineral fillers, stabilizers, lubricants, wax, UV absorbers, processing aids, and other additives as desired. Useful opacifying pigments include titanium dioxide, zinc oxide, and titanate yellow, while useful tinting pigments include carbon black, yellow oxides, brown oxides, raw and burnt sienna or umber, chromium oxide green, cadmium pigments, chromium pigments, and other mixed metal oxide and organic pigments. Useful fillers include diatomaceous earth (superfloss) clay, silica, talc, mica, wallostonite, barium sulfate, and calcium carbonate. If desired, useful stabilizers such as antioxidants can be used and include phenolic antioxidants, while useful photostabilizers include organic phosphates, and organotin thiolates (mercaptides). Useful lubricants include metal stearates, paraffin oils and amide waxes. Useful UV absorbers include 2-(2′-hydroxyphenol) benzotriazoles and 2-hydroxybenzophenones. Additives can also be used to improve the hydrolytic stability of the TPU polymer.

The weight average molecular weight (Mw) of the TPU polymer is generally about 60,000 to about 500,000 and preferably from about 80,000 to about 300,000 Daltons. For applications where steam is used to force the pipe liner against the wall of an existing pipe and to cure the thermosettable resin, the TPU polymer preferably has high temperature performance properties as exhibited by a DSC 2^{nd} heat melt endotherm peak temperature of greater than about 120° C. preferably greater than about 140° C. and more preferably less than about 180° C. This high temperature performance is necessary to prevent holes from forming in the liner during the cured in place installation. The temperature performance properties are measured using a Differential Scanning Calorimetry (DSC) using scan conditions from −100° C. to 230° C. in heat/cool/heat mode at 10° C./min. ASTMD-3418-03 standard describes the DSC test. The 2^{nd} heat melt endotherm peak temperature is used to correct for any variances in the sample.

The most preferred TPU polymers used in the first and third layers of the TPU liner will have a Shore A hardness of from about 85 A to about 98 A, preferably from 85 A to 95 A, and will have a Melt Flow Index of equal to or less than 80 g/10 min. @210° C. and 3.8 Kg load, preferably less than 65 g /10 min. and more preferably less than 50 g/10 min. Calendaring grades of TPU will typically have a Melt Flow Index of about 45 to 80 whereas extrusion grades will typically have a Melt Flow Index of 40 or less. Commercial TPU polymers that meet these requirements are known as Estane® TPU 58437, 58277, 58447, 54605, 54777, T5630, T5620, 58605 and X-1351 and are commercially available from Lubrizol Advanced Materials, Inc. TPU polymers having a hardness higher than 98 Shore A can be too stiff to facilitate the insertion of the liner into the damaged pipe in some applications, particularly by the inversion method. Shore A and Shore D hardness are determined according to ASTM D2240.

When the TPU is to be used for lining gas pipes, it is preferred to use a TPU which is made from a low acid number polyester intermediate and where the polyester intermediate is made by reacting adipic acid with diethylene glycol, as this type of TPU is believed to be more microbial resistant. Resistance to microbes is desirable for gas pipes. The type of TPU used can vary depending on the environment encountered in use and the temperature required for the curing process.

The TPU should also have good resistance to solvents. Solvents can be used to solvent-weld TPU patches over the holes drilled into the liner, which are made to facilitate getting the thermosettable resin into the resin absorbent layer. Solvents also can be used to solvent-weld a TPU tape over the lengthwise seams of the liner to make a closed tube from the original flat rectangular sheet.

### Barrier Layer

A barrier layer (second layer) which is resistant to the migration of styrene is used between the first and third layers discussed above. The thermosetting resin used in the cured-in-place liner is usually a polyester resin which uses styrene to cure the resin. If styrene migrates through the thermoplastic portion of the liner, styrene can contaminate the water or steam used to inflate the liner. If too much styrene is present in the water or steam, the water must be collected and disposed of by more costly means, rather than discharged to a municipal drainage system.

It has been found that a styrene barrier layer can be formed from either a very hard TPU or from an ethylene vinyl alcohol (EVOH) polymer. The barrier layer is preferably placed between the first and third layers. The barrier layer does not have as good of adhesion to the resin absorbent material as the firsthand third layers, thus it is not placed directly onto the resin absorbent material, but rather is placed between the first and third layers. A suitable adhesive could be applied between the barrier layer and the resin absorbent material if it is desired to place the barrier layer directly onto the resin absorbent material.

The barrier layer, is preferably a very hard TPU, with a hardness of 60 Shore D or greater, preferably 65 Shore D or greater, more preferably 75 Shore D or greater, and most preferably about 85 Shore D or greater. The barrier layer, will be described more fully below for the preferred material of a very hard TPU.

The very hard rigid TPU polymer is made by reacting a polyisocyanate with a short chain diol (i.e., chain extender), and optionally less than 15 weight percent of polyol (hydroxyl terminated intermediate as is used in the first and third TPU layer described above). Preferably, the rigid TPU polymer contains less than 5 weight percent polyol, and more preferably zero polyol is present in the rigid very hard TPU polymer. The rigid very hard TPU polymer has a durometer hardness of 60 Shore D or greater, preferably 65 Shore D or greater, more preferably 75 Shore D or greater, and most preferably 85 Shore D or greater.

Suitable chain extenders to make the rigid very hard TPU polymer are preferably lower aliphatic or short chain glycols having from about 2 to about 12 carbon atoms and include for instance ethylene glycol, diethylene glycol, propylene glycol, dipropylene glycol, 1,4-butanediol,1,6-hexanediol, 1,3-butanediol, 1,5-pentanediol, 1,4-cyclohexanedimethanol hydroquinone di(hydroxyethyl) ether, neopehtyglycol, and the like as well as mixtures thereof, with 1,6-hexanediol being preferred. Other glycols, such as aromatic glycols could be used but are not preferred.

Suitable polyispcyanate to make the rigid very hard TPU polymer include aromatic diisocyahates such as 4,4′-methylenebis-(phenyl isocyanate) (MDI); m-xylene diisocyanate (XDI), phenylene-1,4-diisocyanate, naphthalene-1,5-diisocyanate, diphenylmethane-3,3′dimethoxy-4,4′-diisocyanate and toluene diisocyanate (TDI); as well as aliphatic diisocyanates such as isophorone diisocyanate (IPDI), 1,4-cyclohexyl diisocyanate (CHDI), decane-1,10-diisocyanate, and dicyclohexylmethane-4,4′-diisocyanate. The most preferred diisocyanate is 4,4′methylenebis(phenyl isocyanate), i.e., MDI.

Preferably, the rigid very hard TPU polymer is made by reacting the polyisocyanate shown above with the chain extender, without any polyol being present. If polyols are used, they should be used in small amounts of less than up to 15 weight percent, and more preferably less than 5 percent of the total TPU reactants. If used, the polyols, also known as hydroxyl terminated intermediates are used in very small amounts to increase impact strength. The polyols which can be used are any of the normal polyols used in making TPU polymers. These include hydroxyl terminated polyesters, hydroxyl terminated polyethers, and hydroxyl terminated polycarbonates. Preferred hydroxyl terminated intermediates are polymers described in more detail above in the description of the first and third TPU polymer layers.

The level of polyisocyanate preferably diisocyanate, used is the equivalent weight of diisocyanate to the equivalent weight of hydroxyl containing components (i.e., hydroxyl terminated intermediate, if used, and the chain extender glycol). The ratio of equivalent weight of polyisocyanate to hydroxyl containing components is from about 0.95 to about 1.10, and preferably from about 0.96 to about 1.02, and more preferably from about 0.97 to about 1.005.

The reactants to make the rigid very hard TPU polymer are reacted together in preferably a one-shot polymerization process, as is well known to those skilled in the art. The one-shot process, involves feeding the reactants to a heated twin screw extruder where the reactants are polymerized and the polymer is formed into pellets upon exiting the extruder.

Suitable rigid very hard TPU for the barrier layer is available commercially as Isoplast® and HS 85, both available from Lubrizol Advanced Materials, Inc. of Cleveland, Ohio, U.S.A.

### Resin Absorbent Material

A resin absorbent material is used as one layer of the liner. The resin absorbent material is any material which absorbs or holds the thermosettable resin. The resin absorbent layer can be from 0.1 to 20 cm thick, preferably from 0.2 to 15 cm thick and more preferably from 0.3 to 10 cm thick. Suitable resin absorbent materials include fibrous materials of organic or inorganic fibers which may be woven or non-woven fibers. Preferably, the resin absorbent material is a needle punched non-woven material, such as polyester non-woven mat when lining sewers (main or lateral). For lining gas pipes, a glass fiber material is typically preferred.

The TPU polymer of the first layer described above is coated onto one side of the resin absorbent material. Melt processing equipment is used to coat the TPU onto the resin absorbent material. Suitable melt processing equipment includes calender and extrusion processes. The preferred thickness of the TPU coating layer (first layer) on the liner is from about 50 to about 1000 micrometers, preferably from about 100 to about 800 micrometers, and more preferably from about 100 to about 500 micrometers thick. The TPU coating layer (first layer) bonds very well to the polyester non-woven mat without the use of adhesives, thus the polyester non-woven mat is preferred with the TPU coating of this invention.

Often two layers of resin absorbent material are used where the cured-in place liner is designed for larger diameter pipes (such as greater than 25 cm diameter) in need of repair. For use in smaller pipes such as laterals, it is common practice to use a single layer of resin absorbent material.

The TPU coating is made up of three separate layers. The first layer of TPU is coated onto the resin absorbent layer. The second layer, barrier layer, is applied to the first layer and the third layer of TPU is applied to the second layer (barrier layer). The barrier layer should have a thickness of from about 12 micrometers (0.5 mil) to about 75 (3 mils) micrometers, and preferably from about 20 to about 30 micrometers. The barrier layer is very stiff when using a high hardness TPU, and therefore the thicker this layer, the more difficult it would be to install the liner inside a pipe. It has been found that when using a barrier layer of about 1 mil (25 micrometers), the liner can be installed by the inversion method in a pipe needing repair. Although the barrier layer could be thinner than that specified above and still function as a barrier, it is difficult to extrude or calender a film less than 12 micrometers thick. Since extrusion or calendering is the preferred method to produce the film for the barrier layer, it is recommended that a thickness of about 1 mil (25 micrometers) be used. The third TPU layer is placed on the barrier layer. The third TPU layer will have a thickness as described above for the first TPU layer (that is in contact with the resin absorbent layer). The most preferred TPU coating is a three layer TPU coating with the first and third layers each being about 100 micrometers in thickness, and the second layer (barrier) being about 25 micrometers in thickness.

The softer TPU in the first and third layer of the coating needs to be in contact with the resin absorbent layer to achieve good adhesion to the resin absorbent layer. The very hard TPU in the barrier layer does hot have as good adhesion to the resin absorbent layer as the softer TPU used in the first and third layers. Also, the softer TPU of the first and third layers needs to be on the outside layer of the liner, because it is more easier to patch the holes cut into the liner for the purpose of adding the thermoset resin and to glue the seam tape onto the liner to create a cylindrical shape of the liner from the original flat rectangular shape in which the liner is created. The very hard TPU barrier layer is not easy to solvent glue patches or tape to the hard TPU, thus the very hard TPU barrier layer should be sandwiched between two softer TPU layers.

### Liner

To make the liner of this invention, the TPU is melt coated or extrusion coated onto the resin absorbent material. The first layer of softer TPU can be melt coated or extrusion coated onto the resin absorbent material. The third layer of softer TPU can be co-extruded with the very hard TPU barrier layer in a separate step and the combined third layer and barrier layer can be melt applied to the first TPU layer as it is being melt coated onto the resin absorbent material. The liner can also be made in one step by co-extruding or calendering all three layers of TPU as the three layers of TPU coating is applied to the resin absorbent material. A resin capable of being made into a thermoset resin, such as vinyl ester resin or polyester resin, which contains styrene, is added to the resin absorbent material. At this stage (before curing), the liner is flexible and can be placed inside the passageway of a cavity, such as a sewer pipe. The flexible liner can be inserted by either the drag-in or inversion method, which is well known in the art. Once inside the cavity, heat and pressure are added by injecting steam and/or hot water to force the liner against the inside of the pipe and to cure in place the thermoset resin. The liner can also be inserted into the cavity by use of hot water under pressure. Once the resin is cured, it becomes thermoset and the liner becomes rigid to form a rigid pipe within a pipe.

The liner can be made to the desired length required to repair the pipe, and preferably is a continuous tubular liner. The liner should have a length sufficient to repair the pipe with one continuous length that is not required to be spliced together from shorter pieces. The liner will typically be at least 50 meters in length and can be as long as 5000 meters in length. More typical the liners are lengths of from 200 to 1000 meters in length.

The diameter of the liner, once formed into a closed tube will vary depending on the diameter of pipe needing repair. Typical diameters are from about 5 cm to about 250 cm, but more commonly the diameters are 20 cm to about 150 cm.

The liner can conform to the shape of the inside of the pipe needing repair. The shape of the pipe does not need to be perfectly circular, but rather can be non-circular such as egg-shaped or elliptical shaped. The liner can also negotiate bends in the pipe.

After the resin absorbent fabric is impregnated with the thermosettable resin and the liner is made, it is typically stored at a cold temperature, either in an ice bath or a refrigerated truck. This cold storage is necessary to prevent premature curing of the thermoset resin, before it is installed. The liner can be brought to the job site in the refrigerated truck to prevent premature curing of the resin.

After the liner is inserted into the damaged pipe, the resin is cured by exposing the liner to an elevated temperature of usually about 80° C. to 100° C. for 3 to 12 hours. Steam, curing requires less time, usually 3-5 hours as compared to hot water which usually takes 8-12 hours.

The invention will be better understood by reference to the following example.

### EXAMPLES

The Examples are presented to show the improved resistance to styrene permeability of the coating materials of this invention. Examples 1 and 2 are comparative examples where TPU films normally used in cured-in-place pipe liners are evaluated. Examples 3, 4 and 5 are examples of this invention.

The films were evaluated for styrene permeability according to ASTM D814 Inverted Cup Permeability test. The results for styrene permeability are expressed in grams/square meter/day.

Example 1 (comparative) uses a 5 mil thick (127 micrometers) film of a 93 A Shore hardness TPU made from a polyester polyol (adipic acid+1,4-butanediol), 1,4-butanediol chain extender, and MDI. Example 2 (comparative) uses a 5 mil thick (127 micrometers) film of a 95 A Shore hardness TPU made from a polyester polyol (adipic acid+diethylene glycol), 1,4-butanediol chain extender and MDI. Example 3 uses a 5 mil thick (127 micrometers) film of a 62 D Shore hardness TPU made, from a polyester polyol (adipic acid+diethylene glycol), 1,4-butanediol chain extender and MDI. Example 4 uses a co-extruded 5 mil thick (127 micrometers) film which is made up of 1 mil thick (25.4 micrometers) of a 85 Shore D hardness TPU made from chain extender and MDI (no polyol) and 4 mil thick (101.6 micrometers) film of the 93 A Shore hardness TPU used in Example 1. Example 5 uses a co-extruded 5 mil thick (127 micrometers) film which is made up of 1 mil thick (25.4 micrometers) film of EVOH and 4 mil thick (101.6 micrometers) film of the TPU used in Example 1.

The results for styrene permeability of the five films for Examples 1-5 and if the film has sufficient flexibility to be used in a cured-in-place pipe liner while using the inversion method of installation are shown in Table 1 below:

| | | ASTM D814 Styrene |
|---|---|---|
| Example | Film Flexibility | Permeability (g/m²/day |
| 1 | YES | 4800 |
| 2 | YES | 1800 |
| 3 | NO | 190 |
| 4 | YES | 29 |
| 5 | YES | 2.3 |

As can be seen from the results the styrene permeability is greatly reduced when using a very hard (85 Shore D) TPU at a 1 mil thickness together with a soft (93 Shore A) TPU at 4 mils thickness. Also, the co-extruded film using EVOH as the 1 mil barrier layer (Example 5) shows greatly reduced styrene permeability.

While in accordance with the Patent Statutes, the best mode and preferred embodiment has been set forth, the scope of the invention is not limited thereto, but rather by the scope of the attached claims.

What is claimed is:

1. A cured in place liner for a passageway or pipe comprising a layer of thermoplastic polymer material wherein said thermoplastic material is a barrier to styrene migration.

2. The liner of claim 1, wherein said liner comprises a resin absorbent layer.

3. The liner of claim 2, wherein said resin absorbent layer is a non-woven fabric material.

4. The liner of claim 3, wherein said non-woven material is a needle punched polyester non-woven fabric.

5. The liner of claim 1, wherein said barrier layer is selected from the group consisting of ethylene vinyl alcohol polymer and thermoplastic polyurethane, wherein said thermoplastic polyurethane has a hardness greater than 60 Shore D, determined according to ASTM D2240.

6. The liner of claim 5, wherein said barrier layer is a thermoplastic polyurethane having a hardness greater than 80 Shore D, as determined according to ASTM D2240.

7. The liner of claim 1, wherein said barrier layer has a thickness of from about 0.5 mil (12 micrometers) to about 3.0 mils (75 micrometers).

8. A cured in place liner for a passageway or pipe, comprising:
(a) at least one resin absorbent material layer;
(b) a thermoset resin absorbed into said resin absorbent material layer; and
(c) a three layer coating on at least one side of said resin absorbent material layer, said coating comprising:
(i) a first thermoplastic layer in contact with said resin absorbent material layer;
(ii) a second thermoplastic barrier layer disposed between the first and third thermoplastic layers; and
(iii) a third thermoplastic layer.

9. The liner of claim 8, wherein said first and said third layer are the same or different and selected from the group consisting of thermoplastic polyurethane polymers, co-polyamide (COPA) polymers and co-polyester polymers (COPE).

10. The liner of claim 9, wherein said first and said third layer are polyester, thermoplastic polyurethane having a Shore A hardness of from about 85 A to about 98 A, as determined according to ASTM D2240.

11. The liner of claim 8, wherein said second thermoplastic, barrier layer is selected from the group consisting of ethylene, vinyl alcohol (EVOH) polymers and thermoplastic polyurethane, wherein said thermoplastic polyurethane has a hardness of greater than 60 Shore D, as determined according to ASTM D2240.

12. The liner of claim 11, wherein said thermoplastic polyurethane has a hardness of greater than about 80 Shore D, as determined according to ASTM D2240.

13. The liner of claim 8, wherein said barrier layer has a thickness of from about 0.5 mil (1.2 micrometers) to about 3.0 mils (75 micrometers).

14. The liner of claim 8, wherein each of said first and said third layer of said three layer coating has a thickness of from about 50 micrometers to about 1000 micrometers.

15. The liner of claim 14, wherein each of said first and said third layer of said three layer coating has a thickness of from about 100 micrometers to about 500 micrometers.

16. The liner of claim 12, wherein said thermoplastic polyurethane barrier layer is made from reacting a chain extender with a diisocyanate in the absence of a polyol.

17. A method for lining a cavity of a passageway or pipe comprising introducing a liner into said cavity, said liner comprising:
(a) at least one resin absorbent material layer;
(b) a thermosettable resin containing styrene saturated into said resin absorbent material layer;
(c) a three layer coating on at least one side of said resin absorbent material layer, said coating comprising:
(i) a first thermoplastic layer in contact with said resin absorbent material layer;
(ii) a second thermoplastic barrier layer disposed between the first and third thermoplastic layers; and
(iii) a third thermoplastic layer in contact with said barrier layer; introducing steam or water into the inner opening of said liner to force the said liner against the inner surface of said passageway or said pipe and to activate the cure of said thermosettable resin.

18. The method of claim 17, wherein said resin absorbent, material layer is a needle punched non-woven polyester fabric.

19. The method of claim 17, wherein said three layer coating has a thickness of from about 100 to about 1000 micrometers.

20. The method of claim 19, wherein said three layer coating has a thickness of from about 300 to about 500 micrometers.

21. The method of claim 17, wherein said thermosettable resin is selected from the group consisting of vinyl ester resin and polyester resin.

22. The method of claim 17, wherein said pipe is selected from the group consisting of main sewer pipe, lateral sewer pipe, and gas pipe.

23. The method of claim 17, wherein there are two layers of resin absorbent material layers.

24. The method of claim 23, wherein said pipe is at least 10 inches (25.4 cm) in diameter.

25. The method of claim 17, wherein said second barrier layer has a thickness of from about 12 micrometers to about 75 micrometers.

26. The method of claim 25, wherein said second barrier layer is a thermoplastic polyurethane having a hardness greater than 60 Shore D, as determined according to ASTM D2240.

27. The method of claim 26, wherein said second barrier layer is a thermoplastic polyurethane having a hardness greater than 80 Shore D, as determined according to ASTM D2240.
